(19) United States
(12) Patent Application Publication
(10) Pub. No.: US 2026/0218006 A1
(43) Pub. Date: Jul. 30, 2026

(54) TWO-COMPONENT COATING COMPOSITION, AND ARTICLE MADE THEREFROM

(71) Applicant: VALSPAR COATINGS (SHANGHAI) CO. LTD., Shanghai (CN)

(72) Inventors: Xiaoming WU, Shanghai (CN); Qilong CAI, Shanghai (CN); Wanjun XU, Shanghai (CN)

(21) Appl. No.: 19/143,209

(22) PCT Filed: Dec. 29, 2023
(86) PCT No.: PCT/CN2023/143599

§ 371 Date: Jun. 25, 2025

(30) Foreign Application Priority Data
Jan. 3, 2023 (CN) 202310001857.4

(51) Int. Cl. C09D 175/14; C08G 18/08; C08G 18/40; C08G 18/42; C08G 18/62; C09D 7/20

(52) U.S. Cl. CPC C09D 175/14; C08G 18/0852; C08G 18/4063; C08G 18/4277; C08G 18/6229; C09D 7/20

(57) ABSTRACT

The two-component coating composition comprises: Component A: a film-forming resin composition comprising at least one hydroxyacrylic resin, at least one polyester resin, at least one reactive diluent, at least one pigment/filler, and optionally additional additives; and Component B: a curing system comprising at least one hydrophobic polyisocyanate curing agent, wherein the reactive diluent has at least two groups, preferably 2-4 and more preferably 2-3 groups per molecule, the groups being capable of reacting with isocyanate groups; and wherein two-component coating composition has a solid content of at least 75%, preferably at least 78%, based on the total weight of the two-component coating composition, and the two-component coating composition has a VOC of less than 360 g/L, preferably less than 320 g/L. The article comprises a substrate and a coating formed of the above two-component coating composition which is applied to the substrate.

### TECHNICAL FIELD

The present application relates to a two-component coating composition and an article made therefrom.

### BACKGROUND

Solvent-borne coating compositions are often required to have low VOC content as people become more environmentally conscious and regulations become stricter on volatile organic compound (VOC) emissions. For example, in China since February 2015, solvent-borne coating compositions with a VOC content of more than 420 g/L will be subjected to an additional consumption tax of up to 4%, which will significantly increase costs for coating companies.

Traditional film-forming resins, however, are difficult to achieve at the application viscosity required within such VOC range. If by reducing the proportion of diluent, the viscosity is too high, a decline in the appearance and film-forming properties of the coating will be observed, and the ultimate coating cannot meet the performance requirements. In addition, the environmental conditions for application are highly variable, and when the temperature is low, such as in winter, the curing speed and film performance of the coating need to be enhanced.

In order to meet the above needs, the prior art has disclosed reducing the viscosity of a resin by introducing a hyperbranched structure into a polyester resin, thereby obtaining a high-solid, low-viscosity resin composition suitable for solvent-borne coating compositions. However, this method suffers from the difficulty of controlling the process and the tendency of the resin to gel during preparation. The scope for reducing the amount of solvent during the preparation of conventional resin compositions is practically limited, and is usually not less than 20 wt % of the total weight of the resin composition. If an attempt is made to reduce the solvent even further, the resulting resin composition becomes too viscous, or even gels, and thus cannot be used in the formulation of coating compositions. The prior art also discloses the use of glycidyl compounds. For example, CN102702438 discloses the use of glycidyl neodecanoate to prepare a high-solid, low-viscosity acrylic resin. However, the resulting product only achieves a solids content of about 70% and still contains a relatively large amount of organic solvent.

Therefore, in order to meet the VOC content requirement of less than 420 g/L, the coatings industry still needs further improved two-component coating compositions with high solid content, relatively low viscosity, and fast curing.

### SUMMARY

The present application in a first aspect provides a two-component coating composition comprising

Component A: a film-forming resin composition comprising at least one hydroxyacrylic resin, at least one polyester resin, at least one reactive diluent, at least one pigment/filler, and optionally additional additives; and

Component B: a curing system comprising at least one hydrophobic polyisocyanate curing agent;
wherein the reactive diluent has at least two groups, preferably 2-4 and more preferably 2-3 groups per molecule, said groups being capable of reacting with isocyanate groups; and
wherein two-component coating composition has a solid content of at least 75%, preferably at least 78%, based on the total weight of the two-component coating composition, and the two-component coating composition has a VOC of less than 360 g/L, preferably less than 320 g/L.

The present application further provides an article comprising a substrate and a coating applied to at least a portion of the surface of the substrate, wherein the coating is obtained from the above two-component coating composition. The substrate comprises a wood substrate, a plastic substrate, a glass substrate, a ceramic substrate, a polymer composite or a metal substrate, preferably a metal substrate.

The inventors of the present application were surprised to find that in the formulation of the two-component coating composition, by using a high-solid and low-viscosity hydroxyacrylic resin, a high-solid and low-viscosity polyester resin and a high-solid and low-viscosity reactive diluent as Component A in combination with a hydrophobic curing agent, the two-component coating composition which has a low VOC content and can be cured quickly at a low temperature is obtained, with a VOC of less than 360 g/L or even less than 320 g/L, and the curing temperature is between 40-50° C., which significantly shortens the hardness build-up time of the coating, and the resulting coating composition not only has a significantly shorter solid drying time, but also the resulting coating composition has an appropriate application window and is suitable for coating application.

In addition, the inventors of the present application were surprised to find that, in the formulation of the two-component coating composition, a high hydroxyl-value polyester resin having a very low molecular weight (less than 500) was added to the coating composition, by which the application viscosity of the coating was effectively reduced, and the application VOC was reduced; and with respect to the drying speed, through the introduction of a reactive diluent having a special structure (low molecular weight, high functionality, and high reactivity of the primary hydroxyl group) For the drying speed, by introducing the reactive diluent with special structure (low molecular weight, high functionality, high reactivity of primary hydroxyl group), it not only ensures the reduction of application VOC, but also greatly accelerates the drying speed, which is difficult to be foreseen before the present application.

The details of one or more embodiments of the present application are set forth in the description below. Other features, objects, and advantages of the present application will be apparent from the description, and from the claims.

### DETAILED DESCRIPTION

As used herein, “a”, “an”, “the”, “at least one”, and “one or more” are used interchangeably. Thus, for example, a coating composition that comprises “an” additive can be interpreted to mean that the coating composition includes “one or more” additives. The use of the singular form herein is intended to include the plural form unless otherwise indicated herein.

Throughout the present application, where compositions are described as having, including, or comprising specific components or fractions, or where processes are described as having, including, or comprising specific process steps, it is contemplated that the compositions or processes as disclosed herein may further comprise other components or fractions or steps, whether or not, specifically mentioned in the present application, as along as such components or steps do not affect the basic and novel characteristics of the present application, but it is also contemplated that the compositions or processes may consist essentially of, or consist of, the recited components or steps.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

As used herein, “coating” has the same meaning as “paint film”, both of which are formed by applying and drying a two-component coating composition.

In the context of the present application, the term “two-component coating composition” refers to a coating composition consisting of two or more separately stored components, the components of which are mixed upon application together, and can be dried and cured within an acceptable period of time to form a coating with desired mechanical properties such as hardness.

When used in reference to “two-component coating composition”, the phrase “the resulting coating has a pencil hardness of HB or higher” means that the coating formed from the two-component coating composition has an acceptable solid drying effect, wherein a pencil hardness of HB or higher is the parameter used to measure the solid drying effect.

In the context of the present application, the term “solvent-borne coating composition” means a coating composition containing less than 2 g/L of water, preferably essentially free of water, more preferably essentially completely free of water, and still more preferably completely free of water, with an organic solvent as the dispersing medium.

When used with respect to a “solvent-borne coating composition”, the term “substantially free” of water means that the solvent-borne coating composition of the present application comprises less than 1,000 parts per million (ppm) of water; the term “essentially free” of water means that the solvent-borne coating compositions of the present application comprise less than 100 ppm of water; the term “essentially completely free” of water means that the solvent-borne coating compositions of the present application comprise less than 5 ppm of water; the term “completely free” of water means that the solvent-borne coating compositions of the present application contain less than 20 parts per billion (ppb) of water.

When appearing in the specification and claims of the present application, the terms “comprising” and “including” and variations thereof do not have a restrictive meaning.

The terms “preferred” and “preferably” refer to embodiments of the present application that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the present application.

### DETAILED DESCRIPTION

An aspect of the present application provides two-component coating composition comprising

Component A: a film-forming resin composition comprising at least one hydroxyacrylic resin, at least one polyester resin, at least one reactive diluent, at least one pigment/filler, and optionally additional additives; and

Component B: a curing system comprising at least one hydrophobic polyisocyanate curing agent, wherein the reactive diluent has at least two groups, preferably 2-4 and more preferably 2-3 groups per molecule, said groups being capable of reacting with isocyanate groups; and wherein two-component coating composition has a solid content of at least 75%, preferably at least 78%, based on the total weight of the two-component coating composition, and the two-component coating composition has a VOC of less than 360 g/L, preferably less than 320 g/L.

### Film-Forming Resin Composition

The term “film-forming resin composition” refers herein to a resin composition comprising at least one hydroxyacrylic resin, at least one polyester resin, at least one reactive diluent, at least one pigment/filler, and optionally additional additives that constitute the main body of the coating formed by the two-component coating composition of the present application.

In the embodiments according to the present application, the hydroxyacrylic resin has a solids content of at least 75% by weight based on the hydroxyacrylic resin and a viscosity of 15000 mPa·s or less measured at 25° C. using a BROOKFIELD viscometer. In a preferred embodiment according to the present application, the hydroxyacrylic resin has a solids content of at least 78% by weight based on the hydroxyacrylic resin and a viscosity of 10,000 mPa·s or less measured at 25° C. using a BROOKFIELD viscometer.

In an embodiment according to the present application, the hydroxyl value of the hydroxyacrylic resin is not higher than 180 mg KOH/g, preferably in the range of 50-180 mg KOH/g, more preferably in the range of 50-150 mg KOH/g, and still more preferably in the range of 80-120 mg KOH/g, so that the desired curing effect can be achieved. The hydroxyl value is measured by titration according to ISO 4629. If the hydroxyl value of the polymer is too high, the Component A formed from the polymer gels too quickly after mixing with the curing agent and is unsuitable for application operations; if the hydroxyl value of the polymer is too low, the curing reaction between the Component A formed from the polymer and the curing agent is too slow, resulting in a decrease in the application efficiency. Therefore, in some embodiments according to the present application, the hydroxyl value of the hydroxyacrylic resin is appropriate within the above range, which allows the mixture obtained by mixing the Component A containing such resin with the curing agent to have an appropriate pot life.

In an embodiment according to the present application, the hydroxyacrylic resin has an appropriate molecular weight in order to provide sufficient mechanical strength for the resulting coating system. Preferably, the at least one hydroxyacrylic resin has a weight average molecular weight greater than 50,000 g/mol, preferably in the range of 50,000 g/mol to 120,000 g/mol. If the molecular weight of the polymer is too high, the coating composition containing the hydroxyacrylic resin is difficult to be applied uniformly and is unsuitable for application operation; if the molecular weight of the polymer is too low, the film formed from the coating composition containing the hydroxyacrylic resin has a limited strength after curing. Therefore, in some embodiments according to the present application, a molecular weight of the hydroxyl-functional polyacrylate within the above range is appropriate.

The hydroxyacrylic resins disclosed above may, for example, be made by techniques known to those skilled in the art. For example, the hydroxyacrylic resin may be formed from the following monomers:
a) C1-C20 alkyl (meth)acrylates;
b) optionally, vinyl aromatic compounds having up to 20 carbon atoms;
c) ethylenically unsaturated, acid-functional monomers; and
d) hydroxyl C1-C20 alkyl (meth)acrylate.

Within the context of the present application, the term “(meth)acrylates” denotes acrylates, methacrylates and mixtures thereof. Suitable C1-C20 alkyl methacrylates include, but are not limited to, methyl methacrylate, ethyl methacrylate, propyl methacrylate, isopropyl methacrylate, n-butyl methacrylate, sec-butyl methacrylate, tert-butyl methacrylate, pentyl methacrylate, hexyl methacrylate, heptyl methacrylate, octyl methacrylate, 2-octyl methacrylate, 2-ethylhexyl methacrylate, nonyl methacrylate, 2-methyloctyl methacrylate, 2-tert-butylheptyl methacrylate, 3-isopropylheptyl methacrylate, decyl methacrylate, undecyl methacrylate, 5-methylundecyl methacrylate, dodecyl methacrylate, 2-methyldodecyl methacrylate, tridecyl methacrylate, 5-methyltridecyl methacrylate, tetradecyl methacrylate, pentadecyl methacrylate, hexadecyl methacrylate, 2-methylhexadecyl methacrylate, heptadecyl methacrylate, 5-isopropylheptadecyl methacrylate, 5-ethyloctadecyl methacrylate, octadecyl methacrylate, nonadecyl methacrylate, eicosyl methacrylate, cycloalkyl methacrylates (such as, for example, cyclopentyl methacrylate, cyclohexyl methacrylate, 3-vinyl-2-butylcyclohexyl methacrylate, cycloheptyl methacrylate, cyclooctyl methacrylate), bornyl methacrylate, and isobornyl methacrylate. Preference is given to methyl methacrylate, ethyl methacrylate, butyl methacrylate, or tert-butyl methacrylate, and particular preference is given to methyl methacrylate, tert-butyl methacrylate or butyl methacrylate.

Suitable C1-C20 alkyl acrylates include, but are not limited to, methyl acrylate, ethyl acrylate, propyl acrylate, isopropyl acrylate, n-butyl acrylate, sec-butyl acrylate, tert-butyl acrylate, pentyl acrylate, hexyl acrylate, heptyl acrylate, octyl acrylate, 2-octyl acrylate, 2-ethylhexyl acrylate, nonyl acrylate, 2-methyl-octyl acrylate, 2-tert-butylheptyl acrylate, 3-isopropylheptyl acrylate, decyl acrylate, undecyl acrylate, 5-methylundecyl acrylate, dodecyl acrylate, 2-methyldodecyl acrylate, tridecyl acrylate, 5-methyltridecyl acrylate, tetradecyl acrylate, pentadecyl acrylate, hexadecyl acrylate, 2-methylhexadecyl acrylate, heptadecyl acrylate, 5-isopropylheptadecyl acrylate, 5-ethyloctadecyl acrylate, octadecyl acrylate, nonadecyl acrylate, eicosyl acrylate, cycloalkyl acrylates (such as, for example, cyclopentyl acrylate, cyclohexyl acrylate, 3-vinyl-2-butylcyclohexyl acrylate, cycloheptyl acrylate, cyclooctyl acrylate), bornyl acrylate, and isobornyl acrylate. Preference is given to ethyl acrylate, n-butyl acrylate, ethylhexyl acrylate, or cyclohexyl acrylate, and particular preference is given to ethyl acrylate, n-butyl acrylate, or ethylhexyl acrylate.

Suitable vinyl aromatic compounds b) having up to 20 carbon atoms include, but are not limited to, styrene, vinyltoluene, o- and p-methylstyrene, α-butylstyrene, 4-n-butylstyrene, 4-n-decylstyrene, halogenated styrenes, such as, for example, monochlorostyrenes, dichlorostyrenes, tribromostyrenes or tetrabromostyrenes. Styrene is preferred.

Suitable ethylenically unsaturated, acid-functional monomers c) include, but are not limited to, phosphate- or carboxylic acid-functional monomers, preference being given to carboxylic acid-functional monomers such as acrylic acid, methacrylic acid, β-carboxyethyl acrylate, crotonic acid, fumaric acid, maleic anhydride, itaconic acid or monoalkyl esters of dibasic acids or anhydrides such as, for example, maleic acid monoalkyl esters. Particular preference is given to acrylic or methacrylic acid, and acrylic acid is most particularly preferred.

Examples of suitable hydroxyl C1-C20 alkyl (meth)acrylates include, but are not limited to, hydroxyethyl methacrylate, hydroxypropyl methacrylate, hydroxybutyl methacrylate, hydroxyethyl acrylate, and hydroxypropyl acrylate, or hydroxybutyl acrylate.

As an example of a hydroxyacrylic resin, any conventional hydroxyacrylic resin may be used, such as Uralac® CY240 EF-75 from DSM.

In an embodiment according to the present application, the amount of hydroxyacrylic resin may vary over a wide range. For example, the hydroxyacrylic resin may be at most 50 wt %, at most 45 wt %, at most 40 wt %, and is at least 10 wt %, at least 15 wt %, at least 18 wt %, at least 20 wt %, at least 30 wt %, with respect to the total weight of the Component A. In a preferred embodiment according to the present application, the amount of hydroxyacrylic resin, relative to the total weight of the Component A, is in the range of 10 to 40 wt %. Typically, the desired amount of hydroxyacrylic resin may be selected generally empirically based on the film-forming properties of the resulting coating.

In the embodiments according to the present application, the polyester resin has a solid content of at least 85% by weight based on the polyester resin and a viscosity of 10,000 mPa·s or less measured at 25° C. using a BROOKFIELD viscometer. In a preferred embodiment, the polyester resin has a solids content of at least 88% by weight based on the polyester resin and a viscosity of 8000 mPa·s or less measured at 25° C. using a BROOKFIELD viscometer. In a more preferred embodiment, the polyester resin has a solid content of at least 90% by weight based on the polyester resin and a viscosity of 6000 mPa·s or less measured at 25° C. using a BROOKFIELD viscometer.

In the embodiments according to the present application, the polyester resin has a number average molecular weight of up to 1000 g/mol, preferably up to 800 g/mol, more preferably up to 700 g/mol, and most preferably up to 600 g/mol. The inventors have found that the introduction of polyester resins having very low molecular weight into the film-forming resin compositions effectively reduces the coating's application viscosity and reduces the application VOC.

The polyester resin is commercially available, or can be prepared according to the following method: according to the number of molar parts, the small molecule polyol and the caprolactone are mixed, the ring-opening catalyst is added, and the reaction is carried out under the protection of nitrogen at 100-160° C. for 48 h, the disappearance of the IR characteristic peaks of the lactone group of the caprolactone in the reaction system is detected by infrared spectroscopy, and when the solid content of the reaction system is detected as being higher than 99 wt %, the temperature is lowered to obtain caprolactone modified hydroxy polyester; the ring-opening catalyst is one or more of dibutyltin dilaurate, stannous octanoate, anhydrous zinc acetate, tetrabutyl titanate and aluminum isopropoxide.

In an embodiment according to the present application, the amount of the high-solid, low-viscosity polyester resin may vary over a wide range. For example, the amount of the polyester resin may be at most 50 wt %, at most 45 wt %, at most 40 wt %, and is at least 10 wt %, at least 15 wt %, at least 18 wt %, at least 20 wt %, at least 30 wt %, based on the total weight of the Component A. In a preferred embodiment according to the present application, the amount of polyester resin, based on the total weight of the Component A, is in the range of 10 to 40 wt %. Typically, the desired amount of polyester resin may be selected generally empirically based on the film-forming properties of the resulting coating.

In the embodiments according to the present application, the weight ratio of the hydroxyacrylic resin to the polyester resin is in the range of 4:1 to 1:4, preferably in the range of 3:1 to 1:3.

The inventors of the present application were surprised to find that in the formulation of the two-component coating composition, by using a high-solid, low-viscosity hydroxyacrylic resin, a high-solid, low-viscosity polyester resin, and a high-solid, low-viscosity reactive diluent as Component A in combination with a hydrophobic curing agent, they obtained a two-component coating composition with low VOC and capable of curing rapidly at a low temperature, with a VOC of less than 360 g/L or even less than 320 g/L, and the curing temperature is between 40-50° C., which significantly shortens the hardness establishment time of the coating, and the resulting coating composition not only has a significantly shorter solid drying time, but also the resulting coating composition has an appropriate pot life and is suitable for application.

In the embodiments according to the present application, said reactive diluent has at least two groups per molecule, preferably 2-4 and more preferably 2-3 groups per molecule, the groups being capable of reacting with isocyanate groups. As an example, the reactive diluent may be selected from:
1) a polyol alkane or polyamine alkane having a linear or branched chain, which is alkoxylated or non-alkoxylated, preferably having a chain length of C2-C54, more preferably C12-C54 polyol;
2) polyols derived from natural oils or derivatives of corresponding fatty acids, in particular having a chain length in the range C12-C54;
3) polyol oligoethers or oligoimine polyamines'
4) polyol oligoesters, in particular based on caprolactones or neodecanoic acid glycidyl esters;
5) polyol oligomeric carbamates;
preferably the reactive diluent is selected from 4) polyol oligoesters, in particular based on caprolactone or neodecanoic acid glycidyl esters.

In the embodiments according to the present application, the reactive diluent has a hydroxyl value in the range of 280-380 mg KOH/g, preferably in the range of 300-350 mg KOH/g. In an embodiment according to the present application, the reactive diluent has a solids content of 100% and the reactive diluent has a viscosity in the range of 1500-2000 mPa·s measured at 25° C. using a BROOKFIELD viscometer.

In an embodiment according to the present application, the amount of the reactive diluent may be at most 15 wt %, at most 12 wt %, at most 10 wt %, and is at least 4 wt %, at least 5 wt %, and at least 7 wt %, based on the total weight of the Component A. In a preferred embodiment according to the present application, the amount of the reactive diluent, relative to the total weight of the Component A, is in the range of 5 to 15 wt %, preferably in the range of 5 to 10 wt %.

A reactive diluent satisfying the above conditions reduces the viscosity of the system while being reactive (its hydroxyl groups can react with the curing agent NCO). The inventors of the present application were further surprised to find that in the formulation of a two-component coating composition comprising a hydroxyacrylic resin and a polyester resin, by introducing a reactive diluent having a low molecular weight, a high degree of functionality, and a high degree of primary hydroxyl group reactivity to the film-forming resin composition, both a reduction in the application VOC and a greatly accelerated drying speed were ensured. The resulting coating composition, even if it contains a resin that reacts slowly at low temperatures, such as a hydroxyacrylic resin, can achieve rapid and deep curing at low temperatures in a short period of time, which was unforeseeable prior to the present application.

Furthermore, the film-forming resin composition comprises an organic solvent other than the reactive diluent. In the embodiments according to the present application, the other organic solvents are optional in the formulation of the two-component coating composition. In some embodiments according to the present application, the two-component coating composition is free of other organic solvents and is two-component coating composition with an ultra-low VOC. In some embodiments according to the present application, the two-component coating compositions may comprise other organic solvents as carriers to further regulate the viscosity of the coating compositions. The addition of organic solvents may increase the evaporation rate of the coating composition and accelerate the formation of the paint film. In some embodiments of the present application, the organic solvents include ketones (e.g., acetone, methyl isopropyl ketone, methyl isobutyl ketone, etc.), esters (ethyl acetate, butyl acetate, etc.), aromatic hydrocarbons (toluene, xylene, etc.), aliphatic hydrocarbons (cyclopentane, cyclohexane, etc.), or any combination thereof.

In a preferred embodiment according to the present application, the organic solvents other than the reactive diluent may, for example, comprise at least about 5 wt %, at least about 6 wt %, at least about 7 wt %, at least about 8 wt %, at least about 9 wt %, at least about 10 wt % by weight of the total weight of Component A, if present. In a preferred embodiment according to the present application, the organic solvents other than the reactive diluent may, for example, comprise up to about 20 wt %, up to about 16 wt %, up to about 13 wt %, or up to about 12 wt % of the total weight of Component A, if present. Typically, the desired amount of other organic solvents is usually selected empirically based on the film-forming properties of the coating film.

Thus, the two-component coating compositions according to the present application are solvent-borne coating compositions.

In addition, the inventors of the present application were surprised to find that the selection of specific pigment/filler with low oil absorption facilitates further reduction of the viscosity of the coating.

In some embodiments of the present application, the pigment/filler has an oil absorption of less than 50 g/100 g, preferably less than 40 g/100 g, more preferably less than 30 g/100 g. The lower the oil absorption, the lower the viscosity of the coating in general is.

In the present application, oil absorption refers to the minimum grams of oil required to completely wet 100 g of pigment/filler, and the test method is as follows: filling a 25 ml dropping vial with refined linseed kernel oil, weighing it (G₁, accurate to 0.01 g), putting 5.00 g of sample (m, accurate to 0.01 g) on a glass plate, adding part of the linseed kernel oil (10 drops) to the sample by dropper and using a mixing knife to vigorously stir and press the sample to obtain greasy thick material, estimated to stick 90% of the sample and then carefully adding a few drops of oil, until just to get a uniform mass paste until (this process must be completed in 20 to 25 minutes, weighing the weight of the dropping vial as G₂, accurate to 0.01 g):

Oil absorption (g/100 g)=(G₁−G₂)/m*100
in which G₁ represents the mass of the dropping vial after the first weighing, in g;
G₂ represents the mass of the dropping vial after the second weighing, in g;
m represent the mass of the sample, in g.

In some embodiments of the present application, the pigment/filler is selected from one or more of titanium dioxide, iron oxide yellow, copper chromium black, zinc flake, mica powder, talcum powder, ceramic powder, quartz powder, barite powder, glass powder. The pigment/filler may comprise about 5 wt % to about 60 wt % of the film-forming resin composition, and more preferably about 10 wt % to about 50 wt % of the film-forming resin composition.

In the present application, the film-forming resin composition may optionally further comprise conventional additives which do not adversely affect the two-component waterborne polyurethane coating composition or the cured coating obtained therefrom. Suitable additives include, for example, the agents that can improve the processability or manufacturing properties of the composition, enhance the aesthetics of the composition, or improve the specific functional properties or properties of the coating composition or the cured composition obtained therefrom (such as adhesion to the substrate), or reduce the cost. Examples of such additives are for example fillers, lubricants, coalescing agents, wetting agents, plasticizers, defoamers, colorants, antioxidants, flow control agents, thixotropic agents, dispersants, adhesion promoters, UV stabilizers, thickeners, pH adjusters, solvents, or combination thereof. The content of each optional ingredient is sufficient to achieve its intended purpose, but preferably such content does not adversely affect the two-component waterborne polyurethane coating composition or the cured coating obtained therefrom. In a preferred embodiment of the present application, the film-forming resin composition of the present application may contain leveling agents, dispersants, UV stabilizers, antioxidants and drying agents, or any combination thereof as conventional additives. According to the present application, the total amount of conventional additives ranges from 0 wt % to about 20 wt %, preferably from 0.1 wt % to about 16 wt %, relative to the total weight of the film-forming resin composition.

Thus, in a specific embodiment of the present application, based on the total weight of the film-forming resin composition, the film-forming resin composition comprises
a) 10-40 wt % of the hydroxyacrylic resin.
b) 10-40 wt % of the polyester resin
c) 2-15 wt % of the reactive diluent.
d) 10-50 wt % of the pigment/filler.
e) 0-20 wt % of an organic solvent other than the reactive diluent; and
f) 0-15 wt % of additional additives comprising leveling agents, dispersants, UV stabilizers, antioxidants and drying agents.

### Curing System

Coating compositions containing hydroxyl-functional resins preferably employ isocyanates and isocyanurates as curing agents. As an example, the polyisocyanate curing agent may be an aliphatic, alicyclic, and aromatic polyisocyanate, trimethylene diisocyanate, 1,2-propylene diisocyanate, tetramethylene diisocyanate, 2,3-butylene diisocyanate, hexamethylene diisocyanate, octamethylene diisocyanate, 2,4-trimethylhexamethylene diisocyanate, 2,4,4-trimethylhexamethylene diisocyanate, dodecamethylene diisocyanate, 1,3-cyclopentylidene diisocyanate, 1,2-cyclohexylidene diisocyanate, 1,4-cyclohexylidene diisocyanate, 4-methyl-1,3-cyclohexylidene diisocyanate, meta- and p-phenylene diisocyanate, 1,3- and 1,4-bis(isocyanate methyl)benzene, 1,5-dimethyl-2,4-bis(isocyanate methyl)benzene, 1,3,5-triisocyanatebenzene, 2,4-toluene diisocyanate, 2,6-toluene diisocyanate, 2,4,6-toluene triisocyanate, α,α,α′,α′-tetramethyl o-, m-and p-xylylene diisocyanate, 4,4′-diphenylene diisocyanate methane, 4,4′-diphenylene diisocyanate, 3,3′-dichloro-4,4′-diphenylene diisocyanate, naphthalene-1,5-diisocyanate, isophorone diisocyanate, trans-vinylidene diisocyanate, and mixtures of the above-mentioned polyisocyanates.

Since the two-component coating compositions of the present application are solvent-borne coating compositions, the two-component coating compositions further comprise a Component B: a curing system comprising at least one hydrophobic polyisocyanate curing agent.

Preferably, the hydrophobic polyisocyanate curing agent has a viscosity of 1000 mPa·s or less measured at 25° C. using a BROOKFIELD viscometer.

Preferably, the polyisocyanate curing agent is selected from aliphatic or cycloaliphatic polyisocyanates, in particular ureidoformate modified polyisocyanates.

According to the present application, the amounts of the polyisocyanate curing agent and the film-forming resin composition are so selected that the molar ratio of hydroxyl groups (OH) to isocyanate groups (NCO) in the resultant system varies in the range of 1:1 to 1:2.5. Generally, when the molar ratio of the hydroxyl group (OH) to the isocyanate group (NCO) is less than 1:2.5, the operational properties of the resulting two-component coating composition and/or the mechanical properties of the resulting coating may be reduced. When the molar ratio of hydroxyl groups (OH) to isocyanate groups (NCO) is greater than 1:1, the resulting coating has poor curing properties. Depending on the practical need, an additional inert diluent which does not affect the reactivity of the above film-forming resin composition and the polyisocyanate curing agent may be added during the preparation of the film-forming resin composition and/or the polyisocyanate curing agent, for example, to reduce the viscosity of the components. Thus, the amount of the film-forming resin composition and the polyisocyanate curing agent is not limited to the above range, and can be adjusted according to actual needs.

The present application provides a two-component coating composition capable of fast curing and having a low VOC, comprising a high-solid and low-viscosity hydroxyacrylic resin, a high-solid and low-viscosity polyester resin, and a high-solid and low-viscosity reactive diluent as Component A, and a hydrophobic polyisocyanate curing agent as Component B. The two-component coating composition has a VOC of less than 360 g/L, preferably less than 320 g/L, more preferably less than 315 g/L.

As mentioned above, the inventors of the present application were surprised to find that the two-component coating compositions prepared as above are characterized by high hardness, fast surface drying time and rapid hardness build-up, and are particularly suitable for use as topcoat coatings for construction machinery, especially in the rail transportation industry/automotive OEM topcoat and refinish business where higher performance is required. Thus, in some embodiments according to the present application, the two-component coating compositions are automotive refinish paints.

In an embodiment according to the present application, after mixing the Component A and the Component B of the two-component coating composition, the resulting mixture has a pot life of 50 minutes or longer, preferably 60 minutes or longer.

In an embodiment according to the present application, after mixing the Component A and the Component B of the two-component coating composition, the resulting mixture is capable of curing in a time period of 1 hour or less, and the resulting coating has a pencil hardness of HB or higher.

In an embodiment according to the present application, after mixing the Component A and the Component B of the two-component coating composition, the resulting mixture is capable of achieving curing at less than 60° C., preferably at less than 55° C., more preferably at less than 50° C., and the resulting coating has a pencil hardness of HB or higher

In an embodiment according to the present application, after mixing the Component A and the Component B of the two-component coating composition, the resulting mixture is capable of achieving cure at less than 60° C., preferably at less than 55° C., more preferably at less than 50° C., in 1 hour or less, and the resulting coating has a pencil hardness of HB or better.

Another aspect of the present application provides an article comprising a substrate and a coating applied to at least a portion of the surface of the substrate, wherein the coating is obtained from the above two-component coating composition. The substrate comprises a wood substrate, a plastic substrate, a glass substrate, a ceramic substrate, a polymer composite or a metal substrate, preferably a metal substrate.

As a metal substrate for manufacturing the article of the present application, any suitable metal substrate known in the art can be used. As an example, the metal substrate is one or more selected from steel, iron, aluminum, zinc and their alloys.

According to the present application, the article can be prepared, for example, by the following steps: (1) providing a polished substrate; (2) using an applying and curing process to sequentially apply and form one or more two-component coating composition of the present application on the substrate to provide protective properties for the substrate. Optionally, prior to applying the two-component coating composition according to the present application, the substrate has been coated with a paint film, such as an aged paint film, or the paint film on the substrate has been broken.

According to the present application, the articles can be used for the following end-use applications, including but not limited to refrigerated containers and unrefrigerated shipping containers (e.g., dry cargo containers) from suppliers or manufacturers that will be familiar to persons having ordinary skill in the art; chassis, trailers including semitrailers, rail cars, truck bodies, ships, bridges, and building skeletons. Additional uses include metal angles, channels, beams (e.g., I-beams), pipes, tubes, plates and other components that may be welded into these and other metal articles, and the like.

The present disclosure is more particularly described in the following examples that are intended as illustrations only, since numerous modifications and variations within the scope of the present disclosure will be apparent to those skilled in the art. Unless otherwise noted, all parts, percentages, and ratios reported in the following examples are on a weight basis, and all reagents used in the examples are commercially available and used directly without further treatment.

### EXAMPLES

Testing Methods Pot Life

The components of the two-component coating composition according to the present application were mixed and then left to stand. The time required for the viscosity of the system to reach twice the starting viscosity was recorded.

### Pencil Hardness

This test was used to measure hardness of cured coating. Pencil hardness was evaluated using ASTM D3363. The data was reported as the pencil hardness of the last successful test before the coating broke. Thus, for example, if the coating is not broken when tested with a 2H pencil, but cracked when tested with a 3H pencil, the coating is reported to have a pencil hardness of 2H.

### Gloss

This test was used to measure gloss of cured coating. The Sheen orifice gloss meter was used to evaluate 60° gloss according to ASTM D523.

### Aging Resistance

The aging resistance of the coating formed by the two-component coating compositions of this application was evaluated according to GB/T 1865-2009. Materials

TABLE 1

| Materials | Supplier |
|---|---|
| Hydroxyacrylic Resin | Uralac ® CY240 EF-75 fro DSM |
| Polyester resin | AK1088P prepared by SWIMC |
| Reactive diluent | PCL 305 from Daicel, Japan |
| Butyl acetate | General industrial product |
| BYK dispersant | General industrial product |
| Iron oxide yellow pigment | General industrial product |
| Titanium white pigment | General industrial product |
| TIN1130 UV absorber | General industrial product |
| TIN292 light stabilizer | General industrial product |
| DBTDL desiccant | General industrial product |
| BYK leveling agent | General industrial product |
| Xylene | General industrial product |
| Polyisocyanate curing agent | VencorexTolonate ™HDT-LV2 |

### Two-Component Coating Compositions

As shown in Table 2, Component A was obtained by mixing the components for Component A, which was then mixed with Component B to form a mixture. The pot life of the resulting mixture at room temperature was determined as described in the testing section above. The resulting mixture was then applied to the steel plate at a wet film thickness of 100-150 microns, flash-dried for 10 minutes and then cured for 25 minutes at 50° C. Various coating film properties were tested and compared with products already available in the market, and the results obtained were summarized below.

TABLE 2
Curing properties of two-component coating compositions

| | Compar- | Compar- | Compar- | | |
|---|---|---|---|---|---|
| | ative | ative | ative | | |
| | Exam- | Exam- | Exam- | Exam- | Exam- |
| Materials/g | ple 1 | ple 2 | ple 3 | ple 1 | ple 2 |
| Component | | | | | |
| A/g | | | | | |
| Polyester resin | NA | 40 | 28 | 28 | 35 |
| Hydroxyacrylic | 40 | NA | 12 | 12 | 5 |
| Resin | | | | | |
| Reactive | 10 | 10 | | 10 | 10 |
| diluent | | | | | |
| Glycol butyl | | | 10 | | |
| ether | | | | | |
| Butyl acetate | 15 | 15 | 15 | 15 | 15 |
| Dispersant | 2 | 2 | 2 | 2 | 2 |
| Iron oxide | 20 | 20 | 20 | 20 | 20 |
| yellow pigment | | | | | |
| Titanium white | 5 | 5 | 5 | 5 | 5 |
| pigment | | | | | |
| UV absorber | 1 | 1 | 1 | 1 | 1 |
| Light stabilizer | 1 | 1 | 1 | 1 | 1 |
| Desiccant | 5 | 5 | 5 | 5 | 5 |
| Leveling agent | 1 | 1 | 1 | 1 | 1 |
| Total/g | 100 | 100 | 100 | 100 | 100 |
| Component | | | | | |
| B/g | | | | | |
| Polyisocyanate | 90 | 90 | 90 | 90 | 90 |
| curing agent | | | | | |
| Xylene | 10 | 10 | 10 | 10 | 10 |
| Pot life | 80 | 40 | 70 | 60 | 55 |
| @40° C./min | | | | | |
| VOC | 423 | 310 | 420 | 310 | 310 |
| Solid content | 65 | 77 | 66 | 80 | 79 |
| Time required | 50 | 25 | 60 | 25 | 25 |
| for pencil | | | | | |
| hardness to | | | | | |
| reach HB/min | | | | | |
| Pencil | H | HB | H | 2H | H |
| Hardness | | | | | |
| Gloss 60° | 94.2 | 89 | 90 | 93.4 | 92.3 |
| Aging | 2000 | 1500 | 1600 | 2000 | 1600 |
| resistance/h | | | | | |

As can be seen from the results described in Table 2 above, in the formulation of the two-component coating composition, by using a high-solid and low-viscosity hydroxyacrylic resin, a high-solid and low-viscosity polyester resin and a reactive diluent as Component A in combination with a hydrophobic curing agent, a two-component coating composition that has low VOC and is capable of fast curing at a low temperature is obtained, wherein the VOC is lower than 360 g/L or even lower than 320 g/L, and the curing temperature is between 40-50° C., which significantly shortens the hardness build-up time of the coating, and the resulting coating composition not only has a significantly shorter solid drying time, but also the resulting coating composition has an appropriate pot life and is suitable for coating application. The resulting system can also achieve fast and deep curing at low temperatures in a short period of time, and thus the two-component coating compositions of the present application are suitable for use as topcoat coatings for construction machinery, especially in the rail transportation industry/automotive OEM topcoat and refinish business where higher performance is required.

### EMBODIMENTS

Embodiment 1: A two-component coating composition comprising

Component A: a film-forming resin composition comprising at least one hydroxyacrylic resin, at least one polyester resin, at least one reactive diluent, at least one pigment/filler, and optionally additional additives; and

Component B: a curing system comprising at least one hydrophobic polyisocyanate curing agent;

wherein the reactive diluent has at least two groups, preferably 2-4 and more preferably 2-3 groups per molecule, the groups being capable of reacting with isocyanate groups; and wherein two-component coating composition has a solid content of at least 75%, preferably at least 78%, based on the total weight of the two-component coating composition, and the two-component coating composition has a VOC of less than 360 g/L, preferably less than 320 g/L.

Embodiment 2: The two-component coating composition according to embodiment 1, wherein the hydroxyacrylic resin has a solid content of at least 75% by weight based on the hydroxyacrylic resin and a viscosity of 15000 mPa·s or less measured at 25° C. using a BROOKFIELD viscometer.

Embodiment 3: The two-component coating composition according to embodiment 1 or 2, wherein the polyester resin has a solid content of at least 85% by weight based on the polyester resin and a viscosity of 10,000 mPa·s or less measured at 25° C. using a BROOKFIELD viscometer.

Embodiment 4: The two-component coating composition according to any one of embodiments 1 to 3, wherein the hydroxyacrylic resin has a hydroxyl value in the range of 50-200 mg KOH/g.

Embodiment 5: The two-component coating composition according to any one of embodiments 1 to 4, wherein the polyester resin has a number average molecular weight of up to 1000 g/mol, preferably up to 800 g/mol.

Embodiment 6: The two-component coating composition according to any one of embodiments 1 to 5, wherein the hydrophobic polyisocyanate curing agent has a viscosity of 1000 mPa·s or less measured at 25° C. using a BROOKFIELD viscometer.

Embodiment 7: The two-component coating composition according to any one of embodiments 1 to 6, wherein the weight ratio of the hydroxyacrylic resin to the polyester resin is in the range of 4:1 to 1:4.

Embodiment 8: The two-component coating composition according to any one of embodiments 1 to 7, wherein the pigment and filler has an oil absorption of less than 50 g/100 g, preferably less than 40 g/100 g, more preferably less than 30 g/100 g.

Embodiment 9: The two-component coating composition according to any one of embodiments 1 to 8, wherein the reactive diluent has a solid content of 100% and the reactive diluent has a viscosity of 1500-2000 mPa·s measured at 25° C. using a BROOKFIELD viscometer.

Embodiment 10: The two-component coating composition according to any one of embodiments 1 to 9, wherein the reactive diluent is selected from:
1) a polyol alkane or polyamine alkane having a linear or branched chain, which is alkoxylated or non-alkoxylated, preferably having a chain length of C2-C54, more preferably C12-C54 polyol;
2) polyols derived from natural oils or derivatives of corresponding fatty acids, in particular having a chain length in the range C12-C54;
3) polyol oligoethers or oligoimine polyamines'
4) polyol oligoesters, in particular based on caprolactones or neodecanoic acid glycidyl esters;
5) polyol oligomeric carbamates.
preferably the reactive diluent is selected from 4) polyol oligoesters, in particular based on caprolactone or neodecanoic acid glycidyl esters.

Embodiment 11: The two-component coating composition according to any one of embodiments 1 to 10, wherein the reactive diluent has a hydroxyl value in the range of 280-380 mg KOH/g, preferably in the range of 300-350 mg KOH/g.

Embodiment 12: The two-component coating composition according to any one of embodiments 1 to 11, wherein the film-forming resin composition further comprises an organic solvent other than the reactive diluent, the other organic solvent being selected from the group consisting of ketones, esters, aromatic hydrocarbons, aliphatic hydrocarbons, or any combination thereof.

Embodiment 13: The two-component coating composition according to any one of embodiments 1 to 12, wherein, based on the total weight of the film-forming resin composition, the film-forming resin composition comprises:
a) 10-40 wt % of the hydroxyacrylic resin.
b) 10-40 wt % of the polyester resin
c) 2-15 wt % of the reactive diluent.
d) 10-50 wt % of the pigment/filler.
e) 0-20 wt % of an organic solvent other than the reactive diluent; and
f) 0-15 wt % of additional additives comprising leveling agents, dispersants, UV stabilizers, antioxidants and drying agents.

Embodiment 14: The two-component coating composition according to any one of embodiments 1 to 13, wherein the two-component coating composition is a solvent-based coating composition.

Embodiment 15: The two-component coating composition according to any one of embodiments 1 to 14, wherein the polyisocyanate curing agent is selected from aliphatic or cycloaliphatic polyisocyanates, in particular ureidoformate modified polyisocyanates.

Embodiment 16: The two-component coating composition according to any one of embodiments 1 to 15, wherein after mixing Component A and Component B, the resulting mixture has a pot life of 1 hour or longer.

Embodiment 17: A cured coating obtained from the two-component coating composition according to any one of embodiments 1 to 16, wherein, after mixing Component A and Component B, the resulting mixture is capable of achieving curing at less than 60° C., preferably at less than 55° C., more preferably at less than 50° C., and the resulting coating has a pencil hardness of HB or higher.

Embodiment 18: A cured coating obtained from the two-component coating composition of any one of embodiments 1 to 16, wherein, after mixing Component A and Component B, the resulting mixture is capable of achieving cure at less than 60° C., preferably at less than 55° C., more preferably at less than 50° C., in 1 hour or less, and the resulting coating has a pencil hardness of HB or better.

Embodiment 19: An article comprising a substrate and a two-component coating composition of any one of embodiments 1 to 16 or a coating formed therefrom applied on the substrate.

Embodiment 20: The article according to embodiment 19, wherein the substrate comprises a wood substrate, a plastic substrate, a glass substrate, a ceramic substrate, a polymer composite or a metal substrate, preferably a metal substrate.

While the present application has been described with reference to a number of embodiments and examples, those skilled in the art will readily recognize that changes may be made to the present application without departing from the principles disclosed in the foregoing specification.

What is claimed is:

1. A two-component coating composition comprising
Component A: a film-forming resin composition comprising at least one hydroxyacrylic resin, at least one polyester resin, at least one reactive diluent, at least one pigment/filler, and optionally additional additives; and
Component B: a curing system comprising at least one hydrophobic polyisocyanate curing agent;
wherein the reactive diluent has at least two groups, preferably 2-4 and more preferably 2-3 groups per molecule, the groups being capable of reacting with isocyanate groups; and wherein two-component coating composition has a solid content of at least 75%, preferably at least 78%, based on the total weight of the two-component coating composition, and the two-component coating composition has a VOC of less than 360 g/L, preferably less than 320 g/L.

2. The two-component coating composition according to claim 1, wherein the hydroxyacrylic resin has a solid content of at least 75% by weight based on the hydroxyacrylic resin and a viscosity of 15000 mPa·s or less measured at 25° C. using a BROOKFIELD viscometer.

3. The two-component coating composition according to claim 1, wherein the polyester resin has a solid content of at least 85% by weight based on the polyester resin and a viscosity of 10,000 mPa·s or less measured at 25° C. using a BROOKFIELD viscometer.

4. The two-component coating composition according to claim 1, wherein the hydroxyacrylic resin has a hydroxyl value in the range of 50-200 mg KOH/g.

5. The two-component coating composition according to claim 1, wherein the polyester resin has a number average molecular weight of up to 1000 g/mol, preferably up to 800 g/mol.

6. The two-component coating composition according to claim 1, wherein the hydrophobic polyisocyanate curing agent has a viscosity of 1000 mPa·s or less measured at 25° C. using a BROOKFIELD viscometer.

7. The two-component coating composition according to claim 1, wherein the weight ratio of the hydroxyacrylic resin to the polyester resin is in the range of 4:1 to 1:4.

8. The two-component coating composition according to claim 1, wherein the pigment and filler has an oil absorption of less than 50 g/100 g, preferably less than 40 g/100 g, more preferably less than 30 g/100 g.

9. The two-component coating composition according to claim 1, wherein the reactive diluent has a solid content of 100% and the reactive diluent has a viscosity of 1500-2000 mPa·s measured at 25° C. using a BROOKFIELD viscometer.

10. The two-component coating composition according to claim 1, wherein the reactive diluent is selected from.
1) a polyol alkane or polyamine alkane having a linear or branched chain, which is alkoxylated or non-alkoxylated, preferably having a chain length of C2-C54, more preferably C12-C54 polyol;
2) polyols derived from natural oils or derivatives of corresponding fatty acids, in particular having a chain length in the range C12-C54;
3) polyol oligoethers or oligoimine polyamines'
4) polyol oligoesters, in particular based on caprolactones or neodecanoic acid glycidyl esters;
5) polyol oligomeric carbamates.
preferably the reactive diluent is selected from 4) polyol oligoesters, in particular based on caprolactone or neodecanoic acid glycidyl esters.

11. The two-component coating composition according to claim 1, wherein the reactive diluent has a hydroxyl value in the range of 280-380 mg KOH/g, preferably in the range of 300-350 mg KOH/g.

12. The two-component coating composition according to claim 1, wherein the film-forming resin composition further comprises an organic solvent other than the reactive diluent, the other organic solvent being selected from the group consisting of ketones, esters, aromatic hydrocarbons, aliphatic hydrocarbons, or any combination thereof.

13. The two-component coating composition according to claim 1, wherein, based on the total weight of the film-forming resin composition, the film-forming resin composition comprises
a) 10-40 wt % of the hydroxyacrylic resin.
b) 10-40 wt % of the polyester resin
c) 2-15 wt % of the reactive diluent.
d) 10-50 wt % of the pigment/filler.
e) 0-20 wt % of an organic solvent other than the reactive diluent; and
f) 0-15 wt % of additional additives comprising leveling agents, dispersants, UV stabilizers, antioxidants and drying agents.

14. The two-component coating composition according to claim 1, wherein the two-component coating composition is a solvent-based coating composition.

15. The two-component coating composition according to claim 1, wherein the polyisocyanate curing agent is selected from aliphatic or cycloaliphatic polyisocyanates, in particular ureidoformate modified polyisocyanates.

16. The two-component coating composition according to claim 1, wherein after mixing Component A and Component B, the resulting mixture has a pot life of 1 hour or longer.

17. A cured coating obtained from the two-component coating composition according to claim 1, wherein, after mixing Component A and Component B, the resulting mixture is capable of achieving curing at less than 60° C., preferably at less than 55° C., more preferably at less than 50° C., and the resulting coating has a pencil hardness of HB or higher.

18. A cured coating obtained from the two-component coating composition of claim 1, wherein, after mixing Component A and Component B, the resulting mixture is capable of achieving cure at less than 60° C., preferably at less than 55° C., more preferably at less than 50° C., in 1 hour or less, and the resulting coating has a pencil hardness of HB or better.

19. An article comprising a substrate and a two-component coating composition of claim 1 or a coating formed therefrom applied on the substrate.

20. The article according to claim 19, wherein the substrate comprises a wood substrate, a plastic substrate, a glass substrate, a ceramic substrate, a polymer composite or a metal substrate, preferably a metal substrate.
